(19) United States
(12) Patent Application Publication
(10) Pub. No.: US 2018/0170075 A1
(43) Pub. Date: Jun. 21, 2018

(54) VARIABLE LENGTH SHEET PRINTING USING CONTINUOUS SUBSTRATES

(71) Applicant: The Imaging Systems Group Inc., Calgary (CA)

(72) Inventors: Bruce EISENTRAUT, Calgary (CA); James DOMBESKI, Calgary (CA); Mark HOPKINS, Calgary (CA)

(21) Appl. No.: 15/843,887

(22) Filed: Dec. 15, 2017

Related U.S. Application Data
(60) Provisional application No. 62/434,865, filed on Dec. 15, 2016.

(51) Int. Cl. B41J 11/42; B41F 13/02; B41J 11/66; B65H 3/06; B65H 5/06

(52) U.S. Cl. CPC B41J 11/425; B41F 13/025; B65H 2301/121; B65H 3/0669; B65H 5/066; B41J 11/663

(57) ABSTRACT

A hot fuse printer system includes a feeder module adapted to spool a continuous substrate and cut the substrate to a desired length; a sheeting module adapted to feed the cut substrate to a printer module, which includes a hot fuser unit adapted to print on the cut substrate. The feeder module may include at least one sensor configured to determine a length of the substrate. The feeder module, the sheeting module and the printer module are each operatively connected to a controller which is configured to cause the feeder module to cut the substrate in a desired location, the sheeting module to feed the cut substrate to the printer module, and the printer module to print onto the cut substrate in a desired manner.

### FIELD OF THE INVENTION

The present invention relates to a method and system for variable length roll-to-sheet printing.

### BACKGROUND

Commercially available printers using hot fusing print technology do not allow printing substrates such as papers or synthetic materials to remain stationary inside a fuser during or after the printing process. Because of the elevated temperature, substrates will melt, burn, or have visible anomalies left on them. The fusers themselves can also be damaged.

As a result, substrates must be pre-cut to the required length and passed through the printer completely without stopping, in a process referred to as “cut before print”. This differs from other print technologies, which do not use hot fuse printers, that can leave substrates inside the print mechanisms and cut after the substrate is imaged, referred to as “cut after print”. As a result, these cut after print technologies permit use of continuous substrates such as fanfold media or a continuous roll of substrate.

It would be desirable to have a method and system for printing on continuous media using a hot fuse printer.

### SUMMARY OF THE INVENTION

In one aspect, the invention may comprise a method of printing by creating variable length pre-cut substrates from a continuous roll of substrate and pass them through a hot fusing printer. Such a process allows flexibility in printed length without changing or loading substrates with fixed length material, and one type of material, such as a continuous roll or fanfold of substrate, can be stocked and cut to the desired length at print time.

In one aspect, the invention may comprise a hot fuse printer system comprising:

(a) a feeder module adapted to spool a continuous substrate and cut the substrate to a desired length;

(b) a sheeting module adapted to feed the cut substrate to a printer module, wherein the printer module comprises a hot fuser unit adapted to print on the cut substrate.

In one embodiment, the feeder module comprises at least one sensor configured to determine a length of the substrate. The feeder module, the sheeting module and the printer module are each operatively connected to a controller which is configured to cause the feeder module to cut the substrate in a desired location, the sheeting module to feed the cut substrate to the printer module, and the printer module to print onto the cut substrate in a desired manner.

In another aspect, the invention may comprise a method of hot fuse printing using a continuous substrate, comprising the steps of:

(a) feeding the continuous substrate past a sensor which determines a length of the substrate;

(b) cutting the substrate in a desired location; and

(c) feeding the cut substrate into a hot fuse printer module which prints onto the cut substrate in a desired manner.

### BRIEF DESCRIPTION OF THE DRAWINGS

FIG. 1 illustrates a schematic representation of one embodiment of a print system of the present invention.

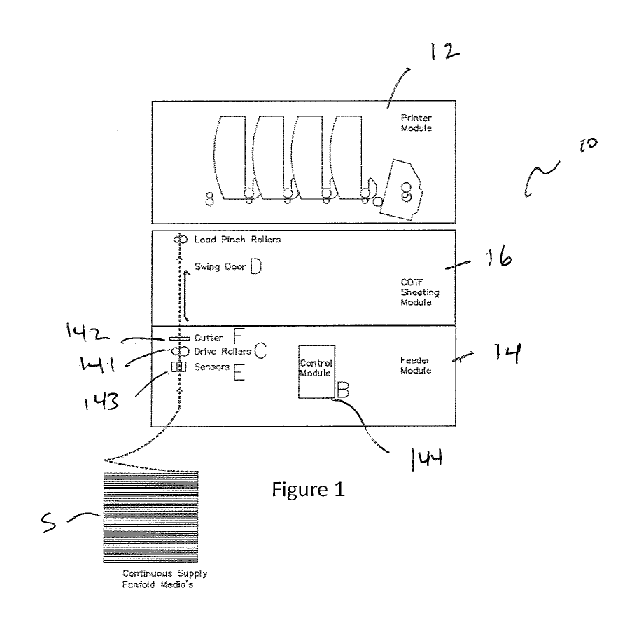

FIG. 2 illustrates an alternative embodiment of a print system of the present invention.

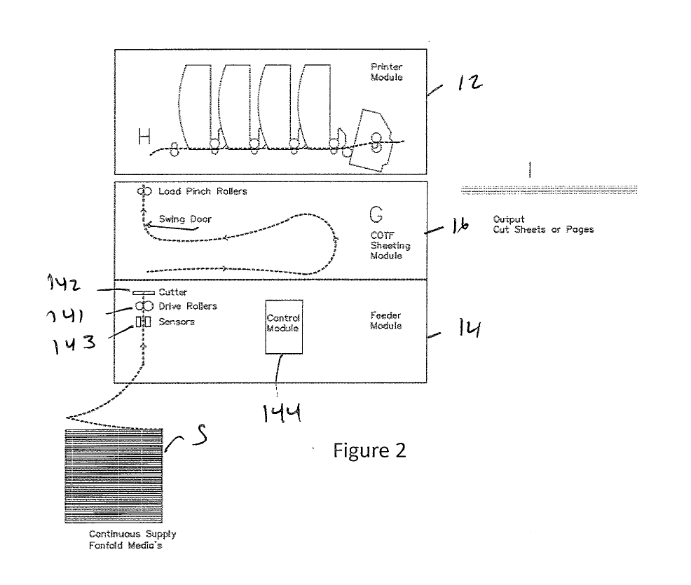

FIG. 3 illustrates another alternative embodiment.

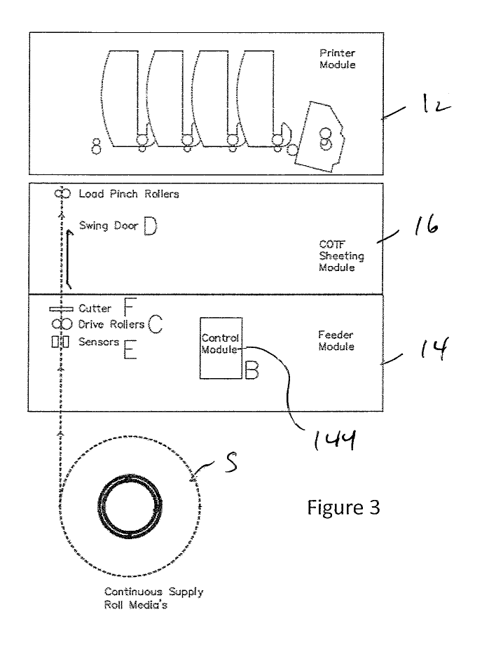

FIG. 4 shows a schematic view of a switch control module and a roller having three heating elements.

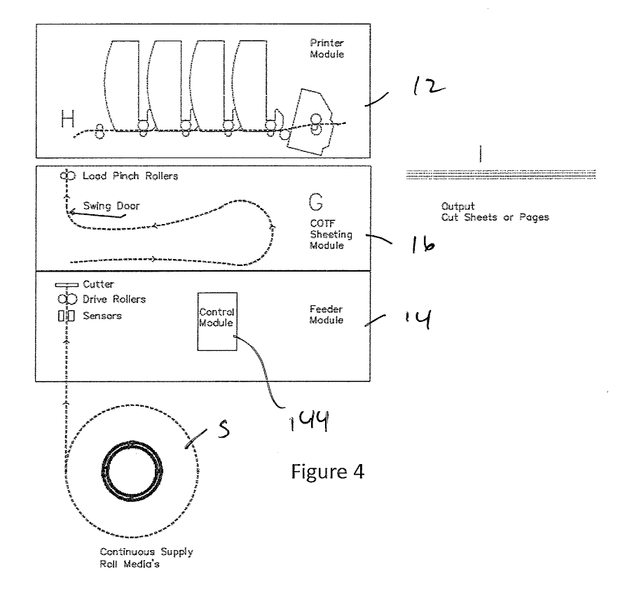

### DETAILED DESCRIPTION

In one embodiment, the invention comprises a method and system for printing on continuous media using a hot fusing printer, such as a laser or LED based toner printer.

In one aspect, the invention comprises a system (10) that automates the pre-cutting of a continuous substrate (S) before being imaged by a hot fuse printer module (12). The system comprises a feeder module (14) which spools and cuts the substrate using drive rollers and a cutter, and a sheeting module (16) which feeds the cut substrate to the printer module using load pinch rollers and a swing door.

The feeder module comprises at least one set of drive rollers (141) to spool the substrate (S) and a cutter (142). The location of the cut is determined by using sensors (143) which directly or indirectly measure the length of the substrate which has been spooled through the feeder module (14). The drive rollers (141) and cutter (142) are controlled by a control module (144) operatively connected to the sensors (143) and the drive rollers (141).

Sensors may comprise an absolute sensor or a displacement sensor. For example, optical sensors which detect registration marks on the substrate may be conveniently used. Alternatively, the sensors may comprise a displacement sensor which, for example, determines substrate length indirectly, such as by counting or measuring the number of rotations of the drive rollers, or by measuring elapsed time if the rollers rotate at a fixed and known speed.

The control module (144) may comprise or form part of a microprocessor based control system to cause the feeder module to spool and cut the substrate at various lengths and feed the substrate into the print module on information input by a user, or received from a central controller (not shown) via a network or other interfacing means.

In one embodiment, the control module may also implement a method to control the printer module (12) to adjust the image placement on the pre-cut substrate to allow desired image placement and full bleed image placement. Many printers utilize substrate placement sensors to detect when the leading edge of the substrate passes through specific locations within the printer. The control module may intercept and modify those sensor signals to place the printed image exactly on or substantially close to the leading edge so as to achieve full bleed printing. If the width and length of the printed image match the cut substrate, then full bleed image placement can be achieved.

The following examples are intended to exemplify particular embodiments of the invention, and not to limit the claimed invention.

### A. Non Die Cut Variable Length Roll to Sheet Printing

In one example, a substrate length is spooled based on information received by the microprocessor controller (144) from a host computer (not shown). The substrate is cut to the specified length, and then fed into the printer module (12) from the sheeting module (16).

### B. Single Die Cut Variable Length Roll to Sheet Printing

In an alternative embodiment, the continuous substrate comprises registration marks or other markers readable by an optical sensor, and a substrate length is spooled based on information received by the microprocessor controller (144) from a host computer and sensor data received from the optical sensor. The substrate is then cut at the centre of the gutter then fed into the printer module (12) from the sheeting module (16).

### C. Multi Die Cut Variable Length Roll to Sheet Printing

In another alternative, a substrate length is spooled based on information received by the microprocessor controller (144) from a host computer and sensor data received from detecting the registration marks, gaps, or other markers in the die cut substrate. Multiple marks/gaps are counted until the desired total is reached. The substrate is cut at the centre of the gutter then fed into the HFP.

The microprocessor controller (144) can control the printer module (12) to adjust the placement of the image on the substrate in any mode. This extended image adjustment range allows the image to be moved to the absolute leading and trailing edges of the substrate resulting in full bleed printing.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A hot fuse printer system comprising:
(a) a feeder module adapted to spool a continuous substrate and cut the substrate to a desired length;
(b) a printer module having a hot fuser unit for printing on the cut substrate;
(c) a sheeting module adapted to feed the cut substrate to the printer module.

2. The printer system of claim 1 wherein the feeder module comprises at least one sensor configured to determine a length of the substrate.

3. The printer system of claim 2 wherein the feeder module, the printer module and the sheeting module are each operatively connected to a controller which is configured to cause the feeder module to cut the substrate in a desired location, the feeder module to feed the cut susbstrate to the printer module, and the printer module to print onto the cut substrate in a desired manner.

4. A method of hot fuse printing using a continuous substrate, comprising the steps of:
(a) feeding the continuous substrate past a sensor which determines a length of the substrate;
(b) cutting the substrate in a desired location; and
(c) feeding the cut substrate into a hot fuse printer module which prints onto the cut substrate in a desired manner.
